(19) United States
(12) Patent Application Publication
(10) Pub. No.: US 2012/0151387 A1
(43) Pub. Date: Jun. 14, 2012

(54) APPARATUS AND METHOD FOR DISPLAYING INTERACTIVE INFORMATION

(75) Inventors: Woo Suk KO, Incheon (KR); Hyoung Sang PARK, Seoul (KR)

(73) Assignee: PANTECH CO., LTD., Seoul (KR)

(21) Appl. No.: 13/227,829

(22) Filed: Sep. 8, 2011

(30) Foreign Application Priority Data
Dec. 13, 2010 (KR) 10-2010-0126692

(51) Int. Cl. G06F 3/048

(52) U.S. Cl. 715/760; 715/781

(57) ABSTRACT

In a method for displaying interactive information of a web page, the method may include parsing a web page to determine if interactive information exists, generating a tool window including the interactive information if the interactive information exists on the web page, and outputting the tool window on a display.

### CROSS-REFERENCE TO RELATED APPLICATION

This application claims priority from and the benefit under 35 U.S.C. §119(a) of Korean Patent Application No. 10-2010-0126692, filed on Dec. 13, 2010, which is hereby incorporated by reference for all purposes as if fully set forth herein.

### BACKGROUND

1. Field

Exemplary embodiments of the present invention relate to an apparatus and a method for displaying content via a mobile terminal, and more particularly, to an apparatus and method for displaying interactive information from the content.

2. Discussion of the Background

As mobile terminals develop, mobile terminals capable of wireless voice is communication and information exchange, in particular, have become widely available. Initially, mobile terminals were provided solely for wireless voice communication. However, with developments in communication technologies and the introduction of wireless internet, mobile terminals may be provided with a wide range of advanced features.

In particular, internet use via mobile terminals has become more popular. However, due to characteristics of mobile terminals, if a mobile terminal displays a general web page rather than a web page created for mobile terminals, the mobile terminal may have difficulty displaying large amounts of content due to a limited display size. Thus, it may be required to repeatedly enlarge/reduce and drag the display to view the entire web page.

### SUMMARY

The following description relates to an apparatus and a method for displaying interactive information of a web page on a mobile terminal.

Additional features of the invention will be set forth in the description which follows, and in part will be apparent from the description, or may be learned by practice of the invention.

An exemplary embodiment provides an apparatus, including a display unit to display a web page; a parsing unit to parse a web page for interactive information; a tool window generating unit to generate a tool window comprising the interactive information; and a tool window outputting unit to output the tool window on the display unit.

An exemplary embodiment provides a method for displaying a web page, including parsing the web page to determine if interactive information exists on the web page; generating a tool window comprising the interactive information; and receiving an input to output the tool window; and outputting the tool window on a display.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to display a web page in a mobile terminal according to an exemplary embodiment of the present invention.

FIG. 2 is a flowchart illustrating a method for displaying interactive information of a web page in a mobile terminal according to an exemplary embodiment of the present invention.

FIG. 3 is a flowchart illustrating a method for displaying interactive information of a web page in a mobile terminal according to an exemplary embodiment of the present invention.

FIG. 4 is a view illustrating interactive information included in a web page according to an exemplary embodiment of the present invention.

FIG. 5 is a view illustrating a tool window generated using interactive information according to an exemplary embodiment of the present invention.

FIG. 6 is a view illustrating a mobile terminal performing a method for determining if a page link button is included in a web page according to an exemplary embodiment of the present invention.

FIG. 7 is a view illustrating a tool window generated using the page link button according to an exemplary embodiment of the present invention.

FIG. 8 is a view illustrating outputs location of a generated tool window according to an exemplary embodiment of the present invention.

FIG. 9 is a view illustrating output locations of two generated tool windows according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for the purposes of this disclosure, “at least one of” will be interpreted to indicate any combination the enumerated elements following the respective language, including combinations of multiples of the enumerated elements. For example, “at least one of X, Y, and Z” will be construed to include X only, Y only, Z only, or any combination of two or more items X, Y, and Z (e.g., XYZ, XZ, YZ).

The exemplary embodiment provide a display apparatus and a method for generating and displaying a tool window using interactive information included in a web page, and outputting the tool window on a display in conjunction with outputting the web page.

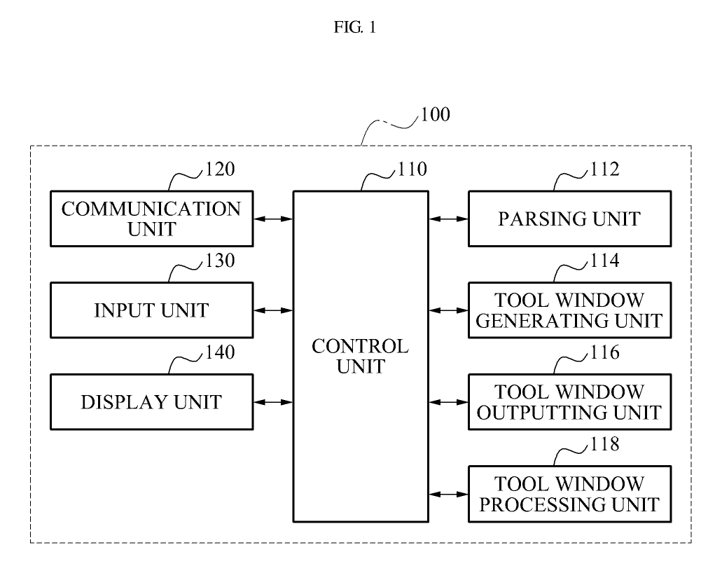

FIG. 1 is a block diagram illustrating an apparatus to display a web page in a mobile terminal according to an exemplary embodiment of the present invention.

Referring to FIG. 1, the mobile terminal 100 includes a control unit 110, a communication unit 120, an input unit 130, a display unit 140, a parsing unit 112, a tool window generating unit 114, a tool window outputting unit 116, and tool window processing unit 118.

The communication unit 120 may transmit and receive data with a wired connection or wirelessly. The communication unit 120 may receive content to provide a service. Hereinafter, content may be used interchangeably with web service, web page, application and the like. Content, applications (such as mobile applications) and the like may be used interchangeably with web pages according to the exemplary embodiments.

The input unit 130 may receive an input requesting an output of a tool window and may provide the input to the control unit 110. A tool window may be a generated list that provides a hyperlink to another page. The input unit 130 may be a touch screen. The input unit 130 may have a plurality of keys including one or more of number keys of 0 to 9, a menu key, a delete key, a confirm key, a call key (TALK), an end key (END), an Internet access key, a navigation key, and the like, and may constitute a key pad for providing the control unit 110 with key input data corresponding to a key that has been pressed.

The display unit 140 may display state information or an indicator, numbers and characters, a moving picture, and a still picture that may occur during operation of the mobile terminal 100. The display unit 140 may also display a tool window including interactive information, generated by the control unit 110.

If the parsing unit 112 receives a web page through the communication unit 120, the parsing unit 112 may determine information with interactive capabilities included in the web page, by parsing the web page.

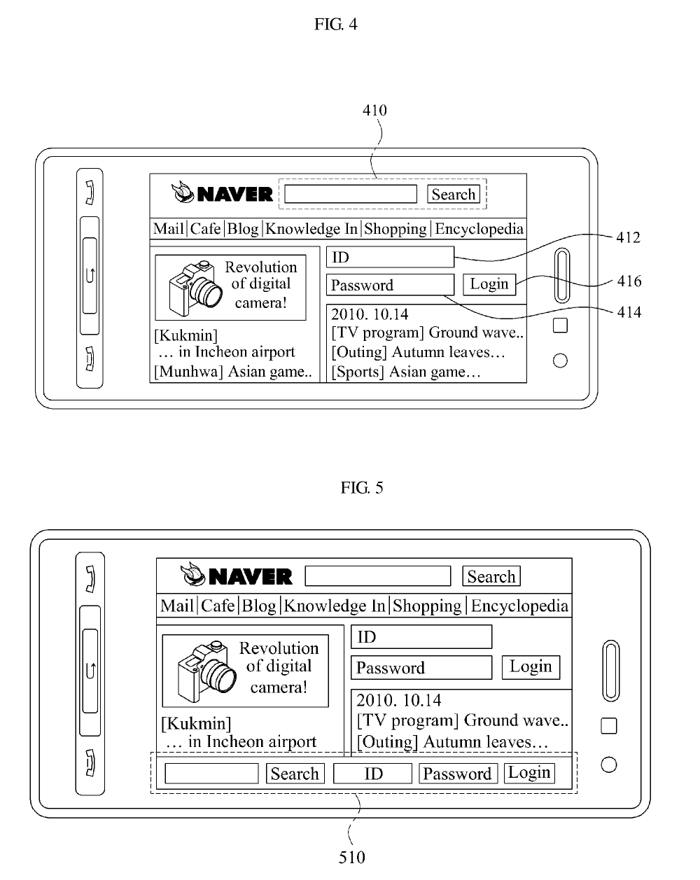

The interactive information may include at least one of an input box in which a text or other user input or selection may be inputted, a name associated with the input box, an approval button (such as an ‘okay’ or ‘go’ button on a web page), and a page link button (or buttons), as shown in the examples of FIG. 4 and FIG. 6. The field for entering an input may be in the shape of a box, as shown in those examples; however, the shape of the input box is not limited to this. The page link button may serve to navigate multiple pages associated with an item of content, such as multiple pages that are retrieved after searching an item through a search engine.

FIG. 4 is a view illustrating interactive information included in a web page according to an exemplary embodiment of the present invention.

Referring to FIG. 4, the parsing unit 112 may determine that various input boxes 410, 412, 414, and a button 416 are located on a web page, through parsing the web page.

FIG. 6 is a view illustrating a mobile terminal performing a method for determining if a page link button is included in a web page according to an exemplary embodiment of the present invention.

Referring to FIG. 6, a mobile terminal 100 may retrieve a web page that is not displayed fully on a display of the mobile terminal 100 due to size of the web page relative to a size of the mobile terminal 100. The web page may include an upper area 610, and if the user scrolls down on the web page, a lower area 620 of the web page may be displayed. This will be described in more detail below. The parsing unit 112 may determine that page link information 622 is located on the web page, through parsing the web page.

In FIG. 6, if the web page that shows a search result outputs an amount of search results over a threshold, the mobile terminal 100 may display the page link information 622 on a lower area 620 of the web page, and not the upper area 610. Thus, if the web page outputs the search results in the mobile terminal 100 in this situation, a portion of the web page, in particular, an upper area 610 of the web page is initially outputted on the display. Therefore, to access the page link information 622 included in the lower area 620, a scrolling operation may be performed to access the lower area 620, thereby allowing access of the page link information 622.

If interactive information is part of a web page (such as page link information 622), the tool window generating unit 114 may generate a tool window including the interactive information that is detected and parsed. In this instance, the interactive information included in the tool window may include all of the interactive information parsed from the web page or only some of the interactive information parsed from a web page. The amount of interactive information included in the tool window may be selectively chosen by a preset setting.

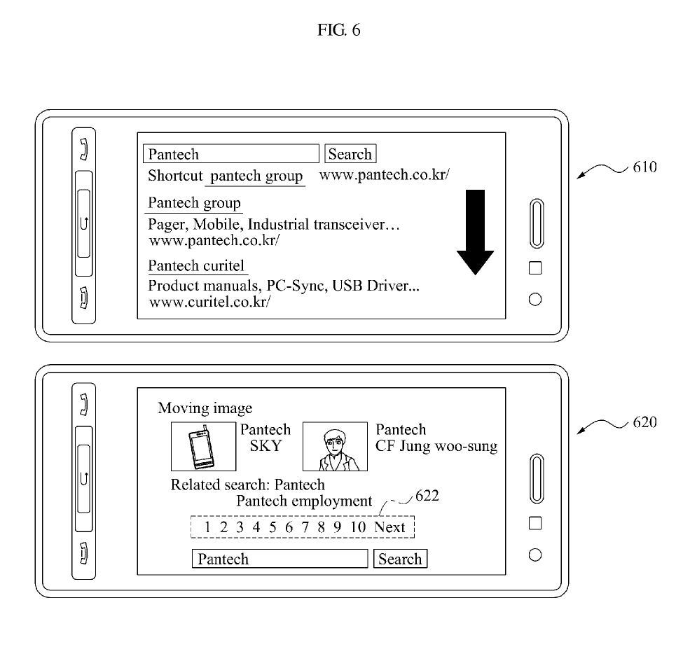

FIG. 5 is a view illustrating a tool window generated using interactive information according to an exemplary embodiment of the present invention.

Referring to FIG. 5, the tool window generating unit 114 may generate a tool window 510 including input boxes 410, 412, and 414, and the button 416, with the input boxes 410, 412, and 414, and the button 416 based on interactive information associated with the web page of FIG. 4. The tool window, which will be described in more detail below, may allow operation on such to replicate the processes associated with the represented inputs.

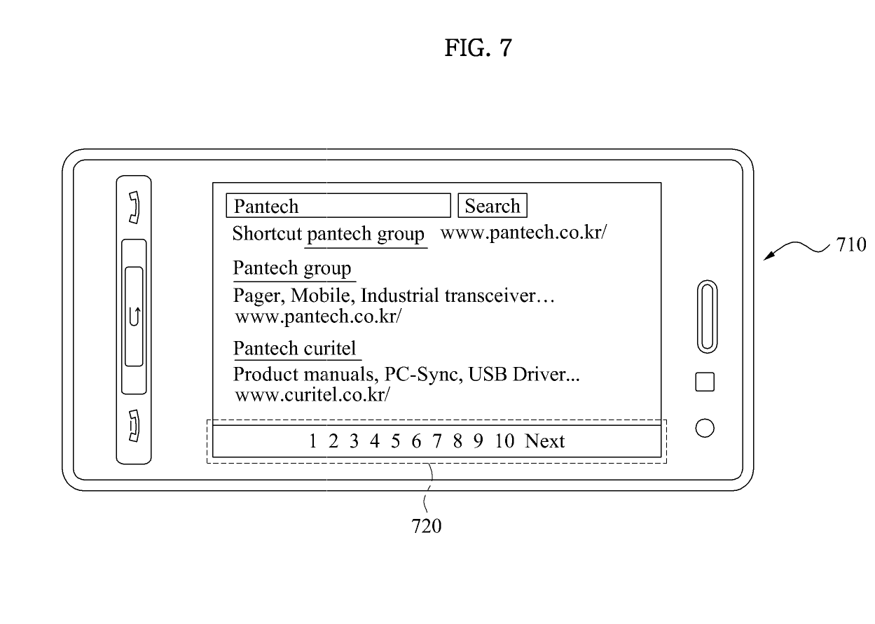

FIG. 7 is a view illustrating a tool window generated using the page link button according to an exemplary embodiment of the present invention.

Referring to FIG. 7, the tool window generating unit 114 may generate a tool window 720 including the page link information 622 corresponding to interactive information included in the web page 620 of FIG. 6.

The tool window generating unit 114 may generate at least two tool windows if interactive information included in the web page is sorted or presented into at least two types based on a standard associated with properties of the interactive information. For example, if the web page has both page link information 622 and another type of interactive information, the tool window generating unit 114 may generate a first tool window associated with page link information 122 and a second tool window associated with the other type of interactive information located on a web page. The sorting standard may be default, predetermined, or selectable by a user before or after the web page is parsed.

The tool window outputting unit 116 may maintain a tool window in a hidden state, and if an input is received, the tool window outputting unit 116 may output the tool window on an area of a display. The input may be represented by at least one of the following: touching an area of a display, a key input corresponding to a predetermined or recognized command, and touching a display in a manner, and the like.

If the tool window generating unit 114 generates a tool window without an input, the tool window outputting unit 116 may immediately output the generated tool window on an area of a display without maintaining the tool window in a hidden state.

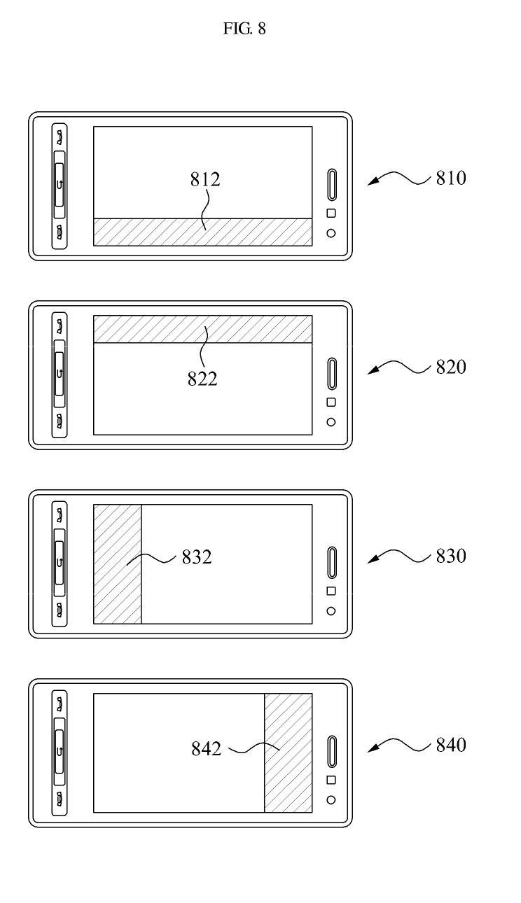

FIG. 8 is a view illustrating output locations of a generated tool window according to an exemplary embodiment of the present invention.

Referring to FIG. 8, the tool window may be outputted on a lower area 812, as shown in a first output display 810. The tool window may be outputted on an upper area 822, as shown in a second output display 820. The tool window may be outputted on a left area 832, as shown in a third output display 830. The tool window may be outputted on a right area 842, as shown in a fourth output display 840.

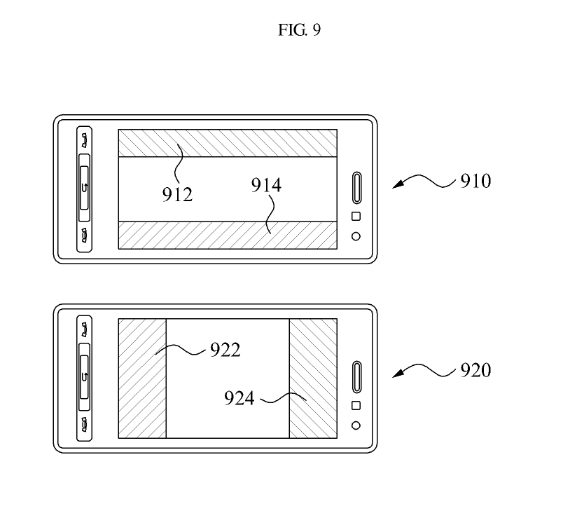

FIG. 9 is a view illustrating output locations of two generated tool windows according to an exemplary embodiment of the present invention.

Referring to FIG. 9, the tool windows may be outputted on an upper area 912 and a lower area 914, as shown in a first output display 910. The tool windows may be outputted on a left area 922 and a right area 924, as shown in a second output display 920. Herein, two orientations of multiple tool windows being displayed are shown. However, other permutations and combinations of two tool windows may be displayed, such as a first tool window on an upper or lower area, and a second tool window on a left or right area. Similarly, tool windows may be relocated by a user using a drag-and-drop operation, or according to preset display scheme, or may be relocated or positioned automatically based on displayed content on the web page. The tool windows may be overlaid on portions of the web page, or the displayed area of the web page may be reduced in scale.

If the tool window generating unit 114 generates a plurality of tool windows, the tool window outputting unit 116 may determine that a tool window associated with a specific type of input from a web page is used to generate the tool window, and may subsequently output the tool window on a specific area of a display. For example, if two tool windows are to be outputted, one on an upper area and one on a lower area, the tool window outputting unit 116 may output the tool window of the upper area, if an input used to generate that tool window is determined to be on the web page. Subsequently, the tool window outputting unit 116 may not output the tool window of the lower area, if an input used to generate that tool window is not determined to be on the web page.

If the tool window processing unit 118 senses an input via a tool window, the tool window processing unit 118 may process an operation or application corresponding to the input. For example, if an input via a tool window is a login input that is executed when an approval button is activate (thus submitting an inputted identification (ID) and a password for approval), the tool window processing unit 118 may process a login operation through interactive information inputted in the tool window.

If an input via a tool window is a selection of one of the page link buttons, the tool window processing unit 118 may load a web page of the selected page link through interactive information included in the tool window that is based on the interactive information of the web page.

The control unit 110 may control the entire, or a partial amount of the operation of the mobile terminal 100. Also, the control unit 110 may perform functions of the parsing unit 112, the tool window generating unit 114, the tool window outputting unit 116, and the tool window processing unit 118. The exemplary embodiment separately discloses the functions of the control unit 110, the parsing unit 112, the tool window generating unit 114, the tool window outputting unit 116, and the tool window processing unit 118 for ease of description. Accordingly, the control unit 110 may include at least one processor configured to perform functions of the parsing unit 112, the tool window generating unit 114, the tool window outputting unit 116, and the tool window processing unit 118. The control unit 110 may include at least one processor configured to perform a portion or combination of the functions of the parsing unit 112, the tool window generating unit 114, the tool window outputting unit 116, and the tool window processing unit 118.

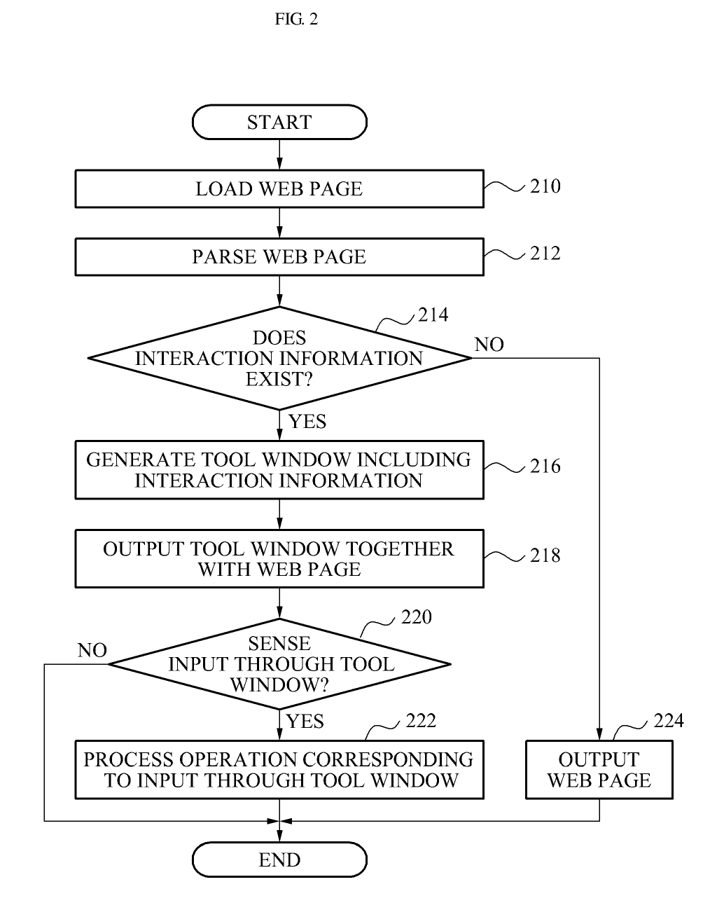

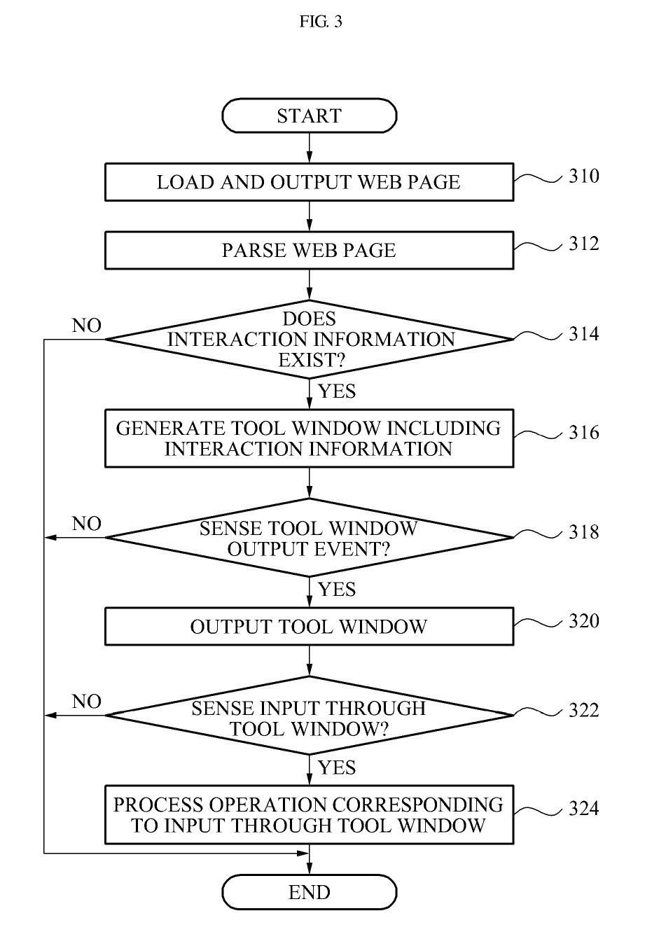

Hereinafter, methods for displaying interactive information of a web page according to exemplary embodiments are described with reference to FIG. 2 and FIG. 3.

FIG. 2 is a flowchart illustrating a method for displaying interactive information of a web page in a mobile terminal according to an exemplary embodiment of the present invention.

Referring to FIG. 2, the mobile terminal 100 may load a web page, in operation 210. As disclosed above, this web page may be a search result page, but is not limited to this type of page. The method shown in FIG. 2 will be described as if performed by mobile terminal 100, but is not limited as such.

In operation 212, the mobile terminal 100 may analyze information included in the loaded web page by parsing the loaded web page.

In operation 214, the mobile terminal 100 may detect whether interactive information exists on the web page. For example, the interactive information may include at least one of an input box for inputting a text or other user input, a name associated with the input box, an approval button, a page link button, and the like.

If interactive information does not exist on the web page, based on the detection in operation 214, the mobile terminal 100 may output the loaded web page, in operation 224.

If interactive information does exist on the web page, based on the detection in operation 214, the mobile terminal 100 may generate a tool window associated with at least one the detected interactive information, in operation 216.

In operation 218, the mobile terminal 100 may output the loaded web page on an area of a display, together with the tool window.

In operation 220, the mobile terminal 100 may determine whether an input via the tool window is sensed.

If an input via the tool window is sensed in operation 220, the mobile terminal 100 may process an operation or application corresponding to the input through the tool window, in operation 222. For example, if the input via the tool window includes a login input, including ID and password, and clicking an approval button for approving the inputted user ID and password, the ID, password and approval button could be selected without scrolling down a screen of the mobile terminal 100. Thus, the mobile terminal 100 may process a login operation through interactive information included in the tool window.

FIG. 3 is a flowchart illustrating a method for displaying interactive information of a web page in a mobile terminal according to an exemplary embodiment of the present invention.

Referring to FIG. 3, in operation 310, the mobile terminal 100 may load and output a web page.

In operation 312, the mobile terminal 100 may analyze information included in the loaded web page by parsing the loaded web page.

In operation 314, the mobile terminal 100 may determine whether interactive information exists on the web page. In this instance, the interactive information may include at least one of an input box for inputting text or another user input, a name of the input box, an approval button, a page link button, and the like.

If interactive information exists on the web page in operation 314, in operation 316, the mobile terminal 100 may generate a tool window including at least one piece of interactive information.

In operation 318, the mobile terminal 100 may detect the occurrence of an input requesting an output of the tool window.

If an input requesting an output of the tool window is detected in operation 318, the mobile terminal 100 may output the tool window on an area of a display, in operation 320.

In operation 322, the mobile terminal 100 may determine whether an input via the tool window is sensed or entered.

If an input via the tool window is sensed or entered in operation 322, the mobile terminal 100 may process an operation based on the input via the tool window, in operation 324. For example, if the input via the tool window is the selection of one of the page link buttons, the mobile terminal 100 may load a web page associated with the selected page link, based on interactive information included in the tool window and interactive information of the corresponding web page.

By creating a tool window on an area of a display, and outputting the web page on the display, the exemplary embodiment may reduce repetition due to enlarging/reducing and dragging operations, which may be caused by a limited display size of a mobile terminal.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
a display unit to display a web page;
a parsing unit to parse a web page for interactive information;
a tool window generating unit to generate a tool window comprising the interactive information; and
a tool window outputting unit to output the tool window on the display unit.

2. The apparatus of claim 1, wherein the interactive information comprises at least one of an input box to receive a user input, a name of the input box, an approval button, and a page link button.

3. The apparatus of claim 1, further comprising:
an input unit to receive an input of the tool window,
wherein the tool window outputting unit outputs the tool window on the display if the input is received.

4. The apparatus of claim 3, wherein the input comprises at least one of: touching an area of the display and activating a key input.

5. The apparatus of claim 1, further comprising:
a tool window processing unit to process an operation corresponding to an input and to sense the input.

6. The apparatus of claim 1, wherein the tool window generating unit generates at least two tool windows comprising interactive information,
wherein the tool window outputting unit outputs each of the tool windows on the display.

7. The apparatus of claim 1, wherein
the tool window generating unit generates at least two tool windows comprising interactive information,
the tool window generating unit further comprises an input unit to receive inputs corresponding to each of the tool windows, and
the tool window outputting unit outputs the corresponding tool window on the display if inputs corresponding to each of the tool windows is received.

8. A method for displaying a web page, comprising:
parsing the web page to determine if interactive information exists on the web page;
generating a tool window comprising the interactive information; and
outputting the tool window on a display.

9. The method of claim 8, wherein the interactive information comprises at least one of an input box to receive a user input, a name of the input box, an approval button, and a page link button.

10. The method of claim 8, further comprising:
receiving an input for the tool window; and
processing an operation corresponding to the input and the interactive information.

11. The method of claim 8, wherein receiving the input comprises at least one of: touching the display, and pressing a key input.

12. The method of claim 8, further comprising:
generating at least two tool windows comprising interactive information;
receiving a first input associated with a first one of the tool windows; and
outputting the first tool window associated with the first input on the display.

13. The method of claim 8, further comprising:
receiving an input to display the tool window.

14. The method of claim 12, further comprising:
receiving a second input associated with a second one of the tool windows; and
outputting the second tool window associated with the second input on the display.

15. The method of claim 10, wherein the operation is an authentication process.

16. The apparatus of claim 1, wherein the tool window comprises types of the interactive information chosen by a user.

17. The method of claim 8, wherein the tool window comprises types of the interactive information chosen by a user.
